(19) United States
(12) Patent Application Publication
(10) Pub. No.: US 2002/0013139 A1
(43) Pub. Date: Jan. 31, 2002

(54) Infinite speed space communications using information globes

(76) Inventor: Robert W. Beckwith, Clearwater, FL (US)

Correspondence Address: Robert W. Beckwith, 2794 Camden Road, Clearwater, FL, 33759-1007, US

(21) Appl. No.: 09/858,938

(22) Filed: May 16, 2001

Related U.S. Application Data
(63) Continuation-in-part of application No. 09/059,738, filed on Apr. 15, 1998, now abandoned.
(60) Provisional application No. 60/043,977, filed on Apr. 23, 1997.

(51) Int. Cl. H04Q 7/20

(52) U.S. Cl. 455/403; 342/357.11

(57) ABSTRACT

Apparatus and methods for divided space globes of electromagnetic energy to travel through universal space at nearly infinite speeds providing real time communications over distances up to interplanetary.

This is a second continuation in part of a first continuation in part of patent application Ser. No. 09/059,738 filed on Apr. 15, 1998 and claims the priority date of provisional patent application Serial No. 60/043,977 filed on Apr. 23, 1997.

Provisional patent application Serial No. 60/043,977 filed on Apr. 23, 1997 contained advanced theories of engineering and physics, especially ones advancing the present inventor's theory of divided (or separated space) which will hereafter be referred to as divided space. Evidence was given supporting the theory of divided space. Patent application Ser. No. 09/059,738 filed on Apr. 15, 1998 added first concepts of sending and receiving devices. First continuation in part patent application Ser. No. 09/059,738 filed on Apr. 15, 1998 further extended the invention.

In this document “I” and “my” will be used to refer to myself, Robert W. Beckwith, as both the inventor and writer of this patent document.

### PRIOR ART

The following quotes are from a book MAN OUT OF TIME by Margaret Cheney.

1—Page 88, Chapter 9 High Road, Low Road: The Niagara Falls Commission . . . for years . . . swayed . . . by the arguments about the dangers of alternating current, announced that it was awarding [Westinghouse] the contract to build the first two generators at Niagara . . . GE had obtained a license to use Tesla patents and proposed a three-phase system. The Westinghouse proposal was for two-phase.

In 1895 the power house was completed . . .

2—Page 116, Chapter 11 To Mars: When reporters arrived, he (Tesla) blandly told them that he could destroy the Brooklyn Bridge in a matter of minutes if he felt like it.

Years later he told Allan L. Benson of other experiments he had made with an oscillator no larger than an alarm clock. He described attaching the vibrator to a steel link two feet long and two inches thick. “For a long time nothing happened . . . But at last . . . the great steel link began to tremble, increased its trembling until it dilated and contracted like a beating heart-and finally broke!”

3—Pages 137 and 138, Chapter 13 Hurler of Lightning: Tesla wrote, it is a resonant transformer which . . . is accurately proportioned to fit the globe and its electrical constants and properties, by virtue of which design it becomes highly efficient and effective in the wireless transmission of energy. Distance is then absolutely eliminated, there being no diminution in the intensity of the transmitted impulses.

Nights when experiments were being made with the magnifying transmitter the prairie sky exploded with sound and color . . . Butterflies were sucked into the vortex of the transmitter coil, which was fifty-two feet in diameter . . . the Tesla magnifying transmitter was the first in the world powerful enough to create ELF resonance in the earth-ionosphere wave guide.

He . . . prediction . . . that the Earth resonates at 6, 18, and 30 Hz.

4—Page 144 Chapter 14 Blackout at Colorado Springs: In a moment he called, “Now! Close the switch!” . . . Tesla had overloaded the dynamo. The town of Colorado Springs was in darkness. As soon as the fire [in the generator] was extinguished a standby generator was put in service, but Tesla's request to be served by it was brusquely denied.

Determined to continue his experiments, he offered to take a team of skilled workmen to the powerhouse and repair the main generator at his own expense. The offer was accepted . . . and Tesla was once more provided with electricity.

5—Page 196, Chapter 19 The Nobel Affair: The current passed through the earth, he elaborated, starting with the transmission station with infinite speed from that region and, slowing down to the speed of light at a distance of 6,000 miles, then increasing in speed from that region and reaching the receiving station with infinite velocity . . . Tesla would resist to the end the idea that light sped faster than anything.

6—Page 272, Chapter 29 The Missing Papers: Within the last month, Tesla told Fitzgerald that his experiments in connection with the wireless transmission of electrical power had been completed and perfected.

7—Pages 284 and 285, Chapter 30 The Legacy: Richard Dickinson, who heads the Microwave Power Transmission for Cal Tech's Jet Propulsion Laboratory . . . near Barstow Calif., traces his inspiration to the early work of Tesla . . . We beamed power . . . a distance of one mile . . . we converted 82.5 percent to useful direct current.

8—Pages 286 and 287, Chapter 30 The Legacy: Also his proposed resonance of the system might be interpreted as the first disclosure of the earth-ionosphere cavity oscillations that have been associated from the early 1960s with W. O. Schumann, N. Christofilos, and J. Galejs, among others.

A further quote is from of a book TESLA MASTER OF LIGHTNING by Margaret Cheney & Robert Uth:

9—Pages 90 & 92, Chapter nine Colorado Springs: For nine months Tesla conducted experiments at Colorado Springs. Though he kept a day-to-day diary that was rich in detail, the results of his experiments are not clear. One question has never been answered definitively: Did Tesla actually transmit wireless power at Pikes Peak? Tesla's first biographer, John J. O'Neill, concludes that he did: It appears evident that Tesla . . . tested his power-transmission system at a distance of twenty-six miles from his laboratory, of the Edison type, with electrical energy extracted from the earth while his oscillator was operating. These lamps consumed about fifty watts each; and if two hundred were used in the test bank, the energy consumed would be 10,000 watts or approximately thirteen horsepower (O'Neill 1944, 197).

I know of no work such as Richard Dickinson's in the beaming of electromagnetic power to include either its use for information transfer or to include the idea of divided space.

### REFERENCES

1: TESLA MAN OUT OF TIME, a book by Margaret Cheney published in 1993 by Barnes & Noble Books, ISBN 0-88029-419-1.

2: TESLA MASTER OF LIGHTNING a book by MARGARET CHENEY & ROBERT UTH published in 1999 by Barnes & Noble Books, ISBN 0-7607-1005-8.

3: “UNITED STATES SHIP CARDINAL (MHC 60)”, a pamphlet dedicating the Navy minesweeper the “Cardinal”. This pamphlet was given to visitors to the Cardinal by public invitation on Sunday May 9, 1999, celebrating Armed Forces Day.

4: U.S. patent application Ser. No. 09/286,068, APPARATUS FOR OBTAINING WORLDWIDE DATA ON THE EARTH'S RESONANT FREQUENCY filed by Robert W. Beckwith on Jul. 23, 1999 included herein by reference.

### SUMMARY OF INVENTION

Universal space is defined by an infinite pattern of far force lines connecting all atoms throughout the universe. Divided space globes are bounded by force lines not connected to any exterior atoms and free to move at nearly infinite speeds through universal space. Globes for communications are created by a vortex of rotating multiple phase electromagnetic field at the Earth's fundamental resonant frequency. A three phase electromagnetic field within the globes has a positive-phase-sequence which provides a force which propels the globes at nearly infinite speed in a selected direction. Readily available 900 mHz transmitting and receiving devices are preferred giving a theoretical top data rate of 900 mbs using non return to zero coding. This assumes one turn of the three phase 900 mHz emf per bit. Communications information, such as video signals, are coded as time sequenced globes with the presence of a globe indicating a binary one and absence of a globe a binary zero.

Receivers consist of a focusing reflector having a bed of quarter wavelength antennae excited by receipt of globes which puncture the globes and receive 900 mHz signals. These signals are reflected to common 900 mHz receivers providing serial binary outputs. The reflector broadens the angle within which the sender must track in direction.

In locations, such as from a planet, where energy from active atmospheric resonance is not available the transmitting antenna is rotated in order to create balls of divided space.

### BRIEF DESCRIPTION OF THE DRAWINGS

FIG. 1 depicts the x, y, and z directions of Euclidean space.

FIG. 2 depicts the time dimension from plus to minus infinity.

FIG. 3 depicts the electrostatic E dimension.

FIG. 4 depicts the force field of universal space.

FIG. 5 depicts any globe of divided space.

FIG. 6 depicts the rotating electromagnetic field of any wave packet.

FIG. 7 depicts a person divided in time.

FIG. 8 not used.

FIGS. 9a to f illustrates apparatus for sending divided space globes.

FIG. 10 illustrates apparatus capable of receiving divided space globes.

### DESCRIPTION OF AND BACKGROUND SUPPORTING THE PREFERRED EMBODIMENT

### ADVANCED THEORIES OF ENGINEERING AND PHYSICS

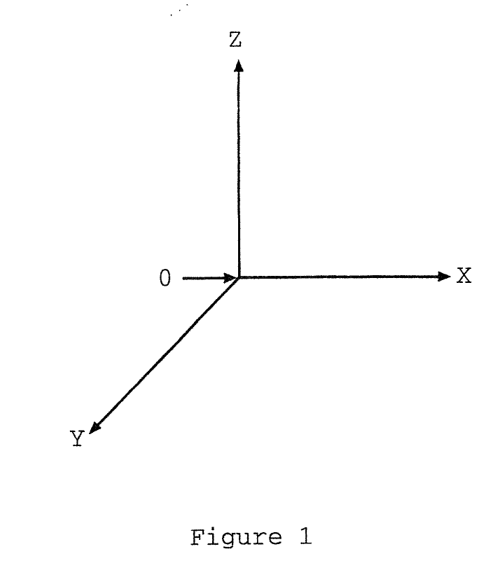

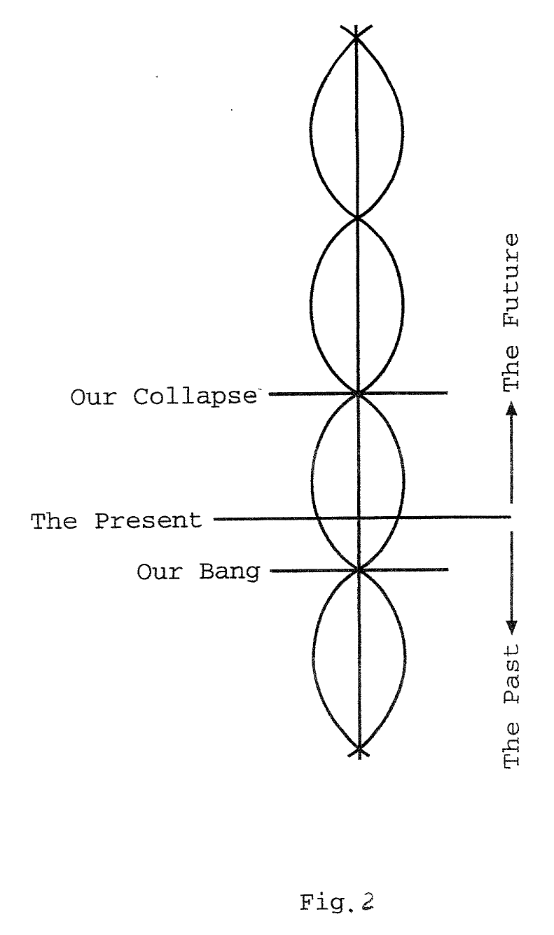

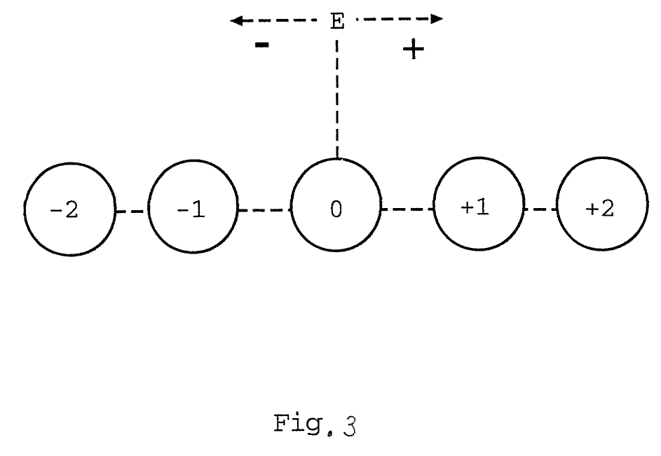

Six well known orthogonal dimensions are used routinely by electrical engineers. The six dimensions of engineering consist of the three dimensions of Euclidean space x, y, and z as shown in FIG. 1, the time dimension T as shown in FIG. 2, the electric field E as shown in FIG. 3. The magnetic field B is not shown but is at right angles to all of the other dimensions.

As to the time dimension, I can not accept a physical universe with five dimensions going from plus to minus infinity but with the time dimension starting at a point to convenience mathematicians in our lifetime here on Earth and their big bang theory. I believe that time also goes from plus to minus infinity with an infinite number of universes collapsing and rebanging chaotically as shown in FIG. 2. Our universes have always been here! With this conclusion we have a well ordered set of six engineering dimensions all of which go from plus to minus infinity.

It is the educated as well as the practical experience of engineers that effects in each of these dimensions are independent of the other five, i.e. the six dimensions are orthogonal. It is well known to electrical engineers how a motor works. It turns, a time function, through some three dimensional positions, using forces produced by the interaction of the E and B fields. It is known that these forces are analog in nature which, however are often conveniently quantized for analytical analysis into force lines of a chosen quanta of force.

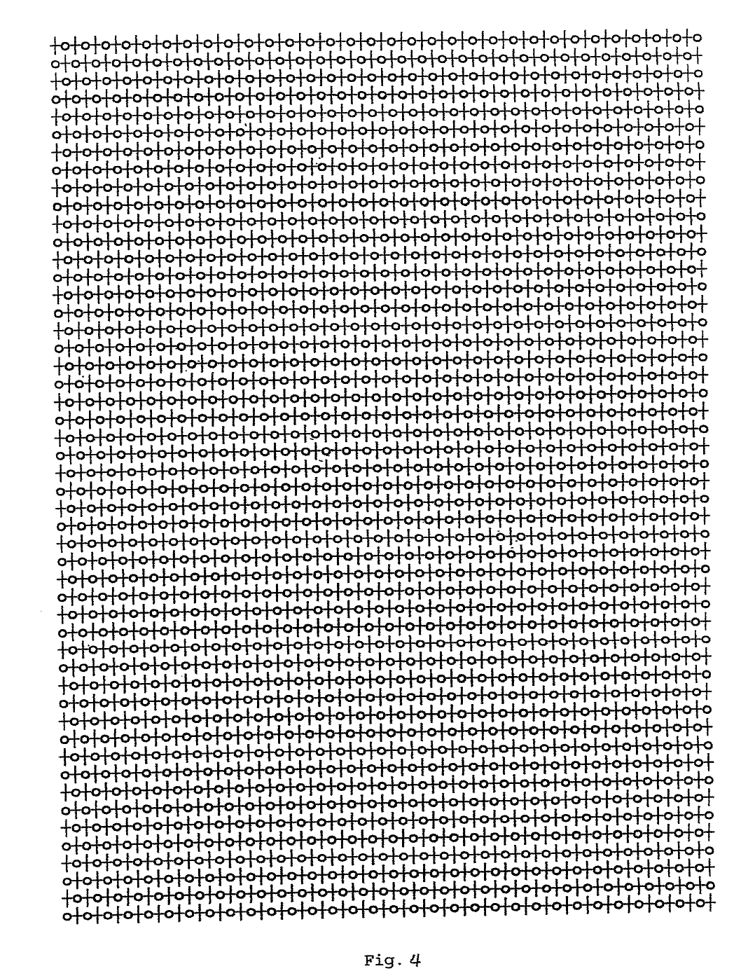

FIG. 4 is a two dimensional representation of the far force lines of universal space holding atoms (o) together with far force lines. For the purposes of illustration, the lines of force in FIG. 4 are quantized into one line per atom vertically and one line per atom horizontally. Familiar laws of physics, especially those related to the speed of light, apply throughout universal space.

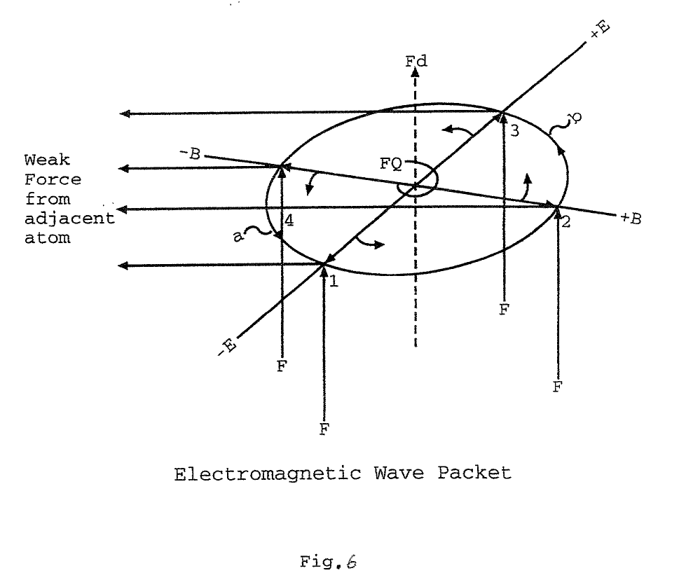

Taking our engineering approach to the macro universe I hypothesize far force lines pulling all neutrons and protons of the universe together thus forming a force model of the universe as shown in FIG. 4. The pull between all of the atoms of ones body (or any other object) and all of the atoms of the Earth creates the effect that we call gravity. I also hypothesize near force lines, as shown in FIG. 6, projecting out some distance from all protons and neutrons of the universe to prevent them from coming together and annihilating each other. By extending the far force model outward we find explanations extending from the effect called gravity here on Earth to the structure of the universe.

Funk & Wagnall's dictionary defines ether (also spelled aether) as: “A solid or semi-solid, perfectly elastic medium formerly assumed to pervade all of space and to be responsible for the transmission of light, heat, gravitational effects and all forms of energy and radiation.”

Aether (preferred herein to avoid confusion with a chemical compound) then consists of far force lines between all atoms of universal space. Aether therefore has a density of the total quantized number of lines in all directions per cubic volume of space, say in lines per cubic centimeter. Aether is a variable, being highest when holding solids together, of moderate magnitude within superclusters of galaxies and zero in dark voids of the universe.

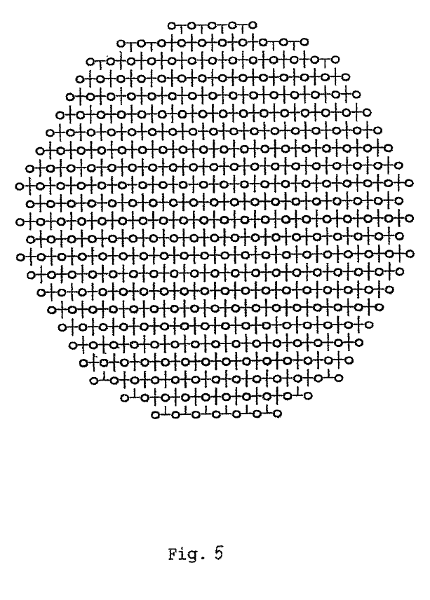

FIG. 5 shows any ball of divided space. Divided spaces in a vacuum or gas tend to form into a globe. FIG. 5, however, is intended to illustrate any volume of space having no far force line connections to universal space. Far force lines connect all atoms within a divided space and familiar laws of physics, especially those related to the speed of light, apply throughout a divided space. However, a divided space is an entity in itself and is not constrained by the laws of the surrounding universal space. A body of divided space can pass through universal space at any rate from zero to infinity.

Electric power transmission uses three phase 60 Hz power transmission voltages and currents. These are modeled by breaking them down into components. One is the positive-phase-sequence component of rotating vectors having a directional force carrying power in a desired direction over three power lines. All other components are undesirable to the ideal transmission of AC electric power. The directional force explains phenomena such as the travel of all electromagnetic packets including photons and neutrinos.

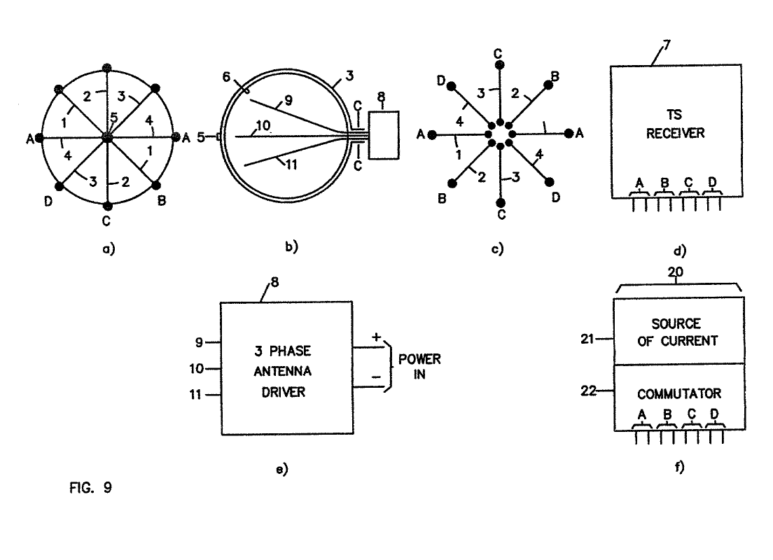

FIG. 6 shows an electromagnetic wave packet with a positive-phase-sequence of rotating forward force F that follows far force lines in a packet direction Fd. This may represent any frequency from a TS wave to a photon or neutrino. The Earth must surely radiate the TS wave into space where it may be detected as Tesla claims to have done in detecting the signal from Mars. The wave may represent the positive-phase-sequence component of current in a three phase transmission line which propels 60 Hz electric power in a desired direction. If the packet is in a near vacuum the speed will travel along far force lines at speeds approaching but never exceeding the speed of light. If the packet suddenly hits an object it will impart its force and seem to behave like a particle. Sometimes it will reflect from the object. FIG. 6 also represents the positive-phase-sequence component of electromagnetic energy created by antennae 9, 10 and 11 of FIG. 9 and contained within a globe of divided space as provided by the apparatus of FIG. 9 then the globe will travel at nearly infinite speed through but not along the far force lines of universal space.

Nicola Tesla was born at precisely midnight between Jul. 9 and 10, 1856 in Smiljan, province of Lika, Croatia. He died a lonely old man in his room at the Hotel New Yorker at 10:30 pm on Jan. 7, 1943.

Tesla recognized the cavity resonator defined by the earth and the ionosphere. He further understood that this is an active cavity with energy contained therein created by lightning strokes from around the world. At an early age Tesla estimated the Earth's fundamental frequency of the stored electromagnetic energy at about 8 cycles per second (Not, of course called Hertz at that early time!). Tesla undoubtedly measured this frequency with great accuracy in his 1899 experiments at Colorado Springs and developed methods of measuring the frequency. Herein the frequency of the fundamental active component of the Earth's electromagnetic energy is termed the Tesla-Schumman (TS) frequency including an honor to W. O. Schumman's work in Germany in the early 1960's. The frequency was used in the next two or three decades as a frequency standard.

Tesla focused his interest in finding ways to send electric power over distances through the earth and the atmosphere as a way of overcoming problems in sending power over long distances by wire. In 1899, at his laboratory at Colorado Springs, Tesla demonstrated the production of artificial lightning from a huge ball on the top of a tower. Not only local artificial lightning but the production of lightning from the ground, fence posts and other conduction objects 100 and 200 miles away. Again he drew wide and frightened audiences especially those 100 and 200 miles away who saw lightning jumping up from fences and other metallic objects on the ground.

Electromagnetic energy of a lightning stroke decreases rapidly with distance. Engineers know of no way to cause lightning strokes at a distance without the help of a phenomena not presently in use. I believe that Tesla introduced Earth's energy into his tower using rotating electric currents in synchronism with the TS frequency thus teleporting lightning energy to remote locations.

It seems unlikely, however, that Tesla experimented heavily with these large scale lightning experiments. The experiments overloaded the local power company, turning the lights off and greatly disturbing the population in general. The electric power company told him that he would get no more free electricity for his laboratory if he turned the lights off again! It is more likely, therefore, that Tesla spent most of his effort in 1899 exploring table top experiments which he could do in secret without objection from the power company.

Cheney and Uth tell of Tesla's intensive experimental work in Colorado Springs for 9 months in 1899 but relate that his notes are very sparing in details. It seems clear that Tesla recognized that he was onto something big and kept a second very secret set of detailed notes whose present location(s) is a mystery. Others more recently have attempted to duplicate Tesla's experiments without success. Could the reason have been that they did not know they should rotate a magnetic field around their equipment at the TS frequency thereby teleporting the energy?

His use of magnetic fields rotating synchronously with the TS frequency to create the effects of levitation, teleportation and time travel is, I believe, Teslas' great secret!

I believe that energy can be extracted by creating a rotating magnetic vortex synchronous with the TS frequency. I believe that neutrinos following these vortex force lines behave like tiny particles and break far force lines around some space causing it to divide. Gifted humans can, I believe, levitate, teleport and time travel by spiraling angles of their DNA molecules off which neutrinos reflect as a vortex placing their body in a divided space.

I believe that Tesla carried out his work on a table having a shelf where he placed objects for experiments in levitating, teleporting and disappearing. The advantages of this work would have been that physical objects can be seen to move in space and disappear in time whereas electromagnetic energy cannot be seen. He may have followed his preference for four phase currents in four wires in this experiment. A reason for this could be that four wires seem to surround objects better for LTT experiments. In fact, intuitively perhaps the more the better. General Electric used three phases on the IX97 experiment described hereinunder. One reason for the choice may have been their experience in three phase for electric power transmission and also because only three wires fit onto a boat.

It is apparent that at some time before his death (Jan. 7, 1943) and at a very low point of World War Two, Tesla told Dr. Edward Teller of his 1899 experiments. This then led to the 1943 experiment in which the Navy moved a boat, the IX97, back two weeks in time from a point in Long Island Sound to berth at Newport R.I.

After getting an engineering degree from Case School of Applied Science I went to work with the General Electric Co. In 1942 I developed highly successful frequency shift keyed (FSK) transfer trip equipment³. This eliminated one high voltage circuit breaker at each substation where generator power was stepped up in voltage for sending over a distance. Our work had the same AAA priority as the Manhattan Project. The equipment became a part of a nationally coordinated electric utility crash program to connect existing generation together into what today has become the national power grid. The specific need in 1942 was to supply power to Oak Ridge and to Hanford for the “Manhattan Project” development of the atomic bomb.

In late 1942, the success of the FSK power line carrier equipment attracted the interest of people at Bell Telephone's Muray Hill Laboratories near Morristown N.J. In a trip by my supervisor at GE, Ed Kenefake, and me to Bell Lab we learned from Dr. Edward Teller of the problem of the bottom anchored German mine with its magnetic detector. Oppenheimer had pretty much taken over technical direction of the Manhattan Project and Dr. Teller took on the problem of the German mine since it seemed we could lose the war by not being able to get troops to England before the development of the bomb was complete.

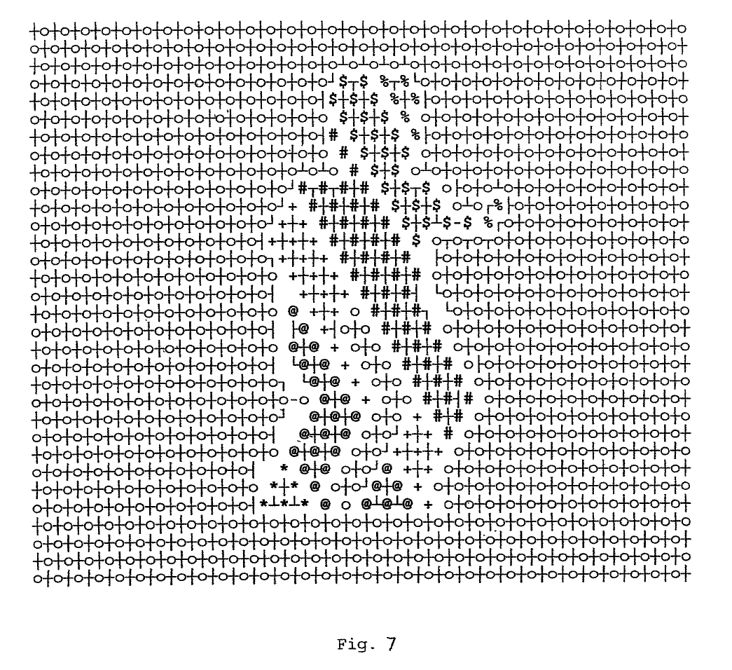

The Germans had developed a floating mine towards the end of WW1 that was set off by a triggering device without necessary physical contact with a ship. These are sometimes referred to as influence mines. It did this by detection of the magnetism of a ships steel hull and screws. FIG. 7 shows the detector consisting of a magnetic triggering device. This has a spring loaded solenoid with a permanent magnet floating in oil against the spring. An orifice through the magnet was calibrated to give the mechanism a resonant frequency in the 5 to 8 Hertz range so as to seek the ships screws where the most crippling damage could be done. Early WW1 floating mines had detonation spikes that exploded the mine when they hit a ship. With the magnetic triggering device the newer WW1 mines would detonate as the ships went past without requiring actual contact.

Between WW1 and WW2 we had developed minesweepers having cables hanging along both sides. The cables formed a loop carrying a low frequency AC current at the resonant frequency of the triggering device. The magnetic field from the current induced the magnetic slug in the triggering device to move making contact while still at some distance from the minesweeper. This caused the WW1 floating type mines to detonate far enough away from the minesweeper so as not to cause damage. Note that the idea of making something vibrate by exciting its resonant frequency comes directly from Tesla.

Then at the start of WW2, the Germans surprised us with a mine anchored to the bottom that would not explode when the detector was first activated by the minesweeper but would rise to the surface just in time to get the minesweeper. This was often fatal to our minesweeper and became a major problem in keeping our shipping lanes open. I don't remember how these mines were laid by the Germans but most likely from submarines just off the US coastline, far removed from the radar war over Europe.

The total WW2 firing mechanism was quite sophisticated in that it would count ships before releasing the mine to the surface. The intent could have been to try to get the minesweeper or perhaps a troop carrier as a more important target than supply ships. For that reason the order of the ships in a convoy as it left a harbor was kept secret. The problem with that was, it wasn't difficult for a spy to watch ships as they left a harbor and report their positions.

When Tesla called Dr. Teller to his death bed towards the end of 1942 he told Teller what he could remember about his experiments in 1899. The Earth's cavity formed between the ionosphere and the magnum is continuously activated by lightning strokes producing an electromagnetic signal at the TS frequency. Lightning strokes around the globe are estimated as many per second on the average. I have seen no estimate of the total energy stored in the Earth's field but it must be enormous.

Being 43 years later and extremely poor health, Tesla must have conveyed the principles of LTT rather well to Teller but failed to get across the importance of exact synchronism with the TS frequency for extraction of energy from the field. As described later hereinunder, the experimenters on the IX97 found out about the dependence on energy from the Earth's resonance by accident and went much further back in time than they intended.

There are several reasons why, in 1899 at Colorado Springs, I believe Tesla learned a great deal about Levitation, Teleportation and Time travel which I call the LTT phenomena.

1. I believe that he switched his fundamental research from experiments with artificial lightning which turned his power off to the movement of objects so that he could see the results and thereby learn principles that he could apply to the teleportation of electric power which he could not see or work with within his laboratory.

2. Earlier he used a small device to measure the frequency of a steel link, to lock onto the frequency and vibrate the link until it broke. In 1899 at Colorado Springs he extended the same principles to measuring and locking onto the TS frequency which he recognized was filled with energy from lightning strokes. I believe that he built a device to create a magnetic field that rotated synchronously with the TS frequency and used it once to teleport artificial lightning to distant locations. He may not have repeated this experiment because of his undesirable experience with the El Paso Power Co. in Colorado Springs.

3. I believe that he conducted experiments while alone in his laboratory for the best part of nine months in 1899 at Colorado Springs in table top experiments. I believe that he kept day to day detailed notes of his work but recorded the significant results in a set of secret notes. I believe that he succeeded in causing objects to move in time. He may well have also found how to make objects levitate and teleport with teleportation the effect he wished to apply in moving electric power.

4. He must have told Dr. Teller how to move something in time since that is what Dr. Teller did with the IX97. The Tesla/Teller conservation and successful application to the IX97 then suggests the form of Tesla's table top equipment. This then in the starting point for inventive apparatus described hereinbelow and my belief that infinite speed communications is possible.

As said before, when Ed Kenefake and I visited Bell Laboratory in 1943 the new problem of the bottom anchored German mines was discussed. Dr. Teller told us of Tesla's experiment and said that he needed to repeat the experiment on the scale of a mine sweeper to solve the problem of this new version of German mine. This new bottom located mine was having a devastating effect on troop ships traveling from the US to England. As Teller told us, there was no time to repeat Tesla's table top experiment. As a result the IX97 became the first ship to time travel. We were told that the IX97 would be used in a time travel experiment with the intent of moving it a mile or so rather quickly as sonar detected a mine moving up from the bottom. This experiment was scheduled in late 1943.

### THE IX97

There were two major problems for electrical engineers during WW2. One was the battle of radar directing our fighters and bombers in their attacks on Hitler's forces over Europe. Our Radar was advanced over the German's and was an important factor in the victories of our air strikes. Sir Watson Watt of England was given credit for the development of Radio Aircraft Detection and Ranging (RADAR) and I remember meeting him at an AIEE winter power meeting in New York City shortly after the war ended.

A second problem was the battle of Sonic Oceanographic Navigation And Ranging (SONAR) against German submarines and mines. Our sonar was made by the Submarine Signal Co. of Groton Conn. as was the sonar of all other nations. I remember working with engineers from Sub Signal who bragged about furnishing all of the sonar to the German and Japanese navies. As a result both the Germans and the Japanese had 17 kHz sonar whereas only the U.S had Sub Signal's 26 kHz version. Neither enemy country had developed sonar technology and couldn't catch up with ours during WW2. The older technology used essentially electro-magnetic (EM) ‘big loudspeaker’ technology and our newer sonar heads used a then very secret barium titanate transducer. (Such chips now form our modern ceramic microphones, speakers and even singing chips in greeting cards.)

Sonar heads could be extended downward from surface ships much as an upside down periscope. The sonar was generally built in place on submarines. The EM sonar heads operated at frequencies of about 17 kHz. Ours, on the other hand, used newly developed barium titanate transducers operating above the audible band at about 26 kHz. We could hear them but they could not hear us!

I remember visiting the IX97 at Brewer's Drydock Co., Staten Island N.Y. with Dr. Horton to get details of how to mount and connect up our equipment. Installation of the 26 kHz sonar was being done at the yard. The shipyard was not in the best part of town and I remember Dr. Horton telling me that all of shipyard workers were good guys and not to be concerned.

Quoting from the “Dictionary of American Naval Fighting Ships”¹⁰, FIG. 9 “shows the Martha's Vineyard (IX97) (that) was built as a motor yacht by the Charles L. Seabury Co. Consolidated, New York, N.Y., in 1911; acquired by the Navy under the name Thelma from George A. Miller, Jr. New London, Conn. Jan. 11, 1943; renamed Martha's Vineyard Jan. 23, 1943; converted by Brewer's Drydock Co., Staten Island N.Y.; and placed in service Mar. 30, 1943, Lt. William W. Boyton, USNR, in command.”

“Assigned to the 3d Naval District, Martha's Vineyard departed New York Navy Yard, New York N.Y., April 4 for New London, Conn., arriving the same day. Two days later Navy and civilian scientists from the Underwater Sound Laboratory, New London, embarked to cruise Long Island Sound until the 12th testing new sound equipment. She spent the next 3 years in similar test operations along the New England coast interspersed with training exercises off Newport, R.I. Martha's Vineyard decommissioned and was stripped at New York Naval Shipyard before she was delivered September 6 of that year to WSA for return to her owner.”

When we got to New London, after the IX97 time travel trip, we found that the IX97 had remained in New London for our work and that the Sardonyx was there also.

As said above, during our visits to Bell Lab in 1943 we heard of the program to quickly move a minesweeper out of the way a mile or so when a mine was detected by sonar as rising from the bottom. In 1944 as we were working out of New London, the amazing happening with the IX97 became the constant scuttlebutt conversation during meals and idle time as our boats moved in and out of the New London harbor. The stories were about the disappearance and movement of the IX97 and disturbing results that led the skipper, William W. Boyton, USNR, and Dr. Horton to quickly shut down the experiment when they suddenly found themselves at the dock in Newport R.I. They had moved back two weeks to the time when the IX97 was docked at Newport R.I. nearby the General Electric Pittsfield Mass. plant from which three current generators were installed.

Dr. Horton told us of raising the three currents to the upper limit and being disappointed that nothing had happened. They then tweaked the frequency resulting in the unexpected jump to the Newport R.I. dock. Undoubtedly they had rather accidentally passed through the TS frequency.

Skipper Lt. Bill Boyton and Dr. Horton, in charge of the time travel experiment, may have been completely enclosed in the inner cabin's divided space and ‘went along for the ride’ with no ill effects. The IX97 may have stayed in Newport only long enough for those two frightened operators of the experiment to see where they were and suddenly turn off the power bringing the ship back to Long Island Sound.

Unfortunate sailors on deck were not totally within the divided space within the cabin and must have been partly moved in time giving them the mind disturbing time/space separation of FIG. 8. It may be that the bodies of the sailors on the deck of the IX97 had become separated into a number of isolated spaces. In FIG. 8 the areas marked by % are in a first zone, by $ in a second, by # in a third, by + in a fourth, by @ in a fifth and in * in a sixth. If so, heat and nerve signals could not flow across the dividing boundaries. It is easy to visualize the disruption of the functioning of a body so divided.

One most unfortunate mate fell from the deck to a position where he was trapped in the steelwork. Part of his body was inside and part outside of a cowling just forward of a port side cabin sliding door. I was shown fresh paint to cover his blood stains on the inside and outside of this curved cowling intended to keep water from coming through the sliding doors in heavy seas.

I found as we operated with seas coming over the bow that the cowling was not very effective. The floor inside of the cabin became wet and slippery!

It appears that the IX97 time travel trip was planned in part at least, by Dr. Horton and others at Bell Lab with people at the Underwater Sound Lab operated by Bell Lab. We worked with the Underwater Sound Lab in our communications experiment. The IX97 must have been the minesweeper involved since what other reason would there have been for the third overhead ‘degaussing’ cable that we saw when we used the IX97? Scuttlebutt about the time trip came out in casual conversation with several who had been involved who simply couldn't keep the amazing experience a secret. I followed the general WW2 rule of keeping secrets during the war and did not discuss the stories with anyone outside of the group with whom I was working.

Lets move to the United States Ship Cardinal⁶ (MHC 60) as obtained from the book covering the Commissioning Ceremony Oct. 18, 1997. Quoting from the book: (p1) “The USS CARDINAL is the tenth ship of the OSPREY (MHC 51) Class, the Navy's newest Minehunter and the fourth ship of the Fleet to bear the name CARDINAL.”

(p36) “The shipbuilder was Intermarine USA, Savannah, Ga. Intermarine USA was established in 1987 bringing the technology of Europe's foremost designer and manufacturer of military GRP ships, Intermarine SpA of Sarzana, Italy, together with the shipbuilding and industrial strength of the United States. This venture resulted in a “composites” shipbuilding facility unequaled in the western hemisphere today.”

“The ship was the glass reinforced Plastic (GRP) Coastal Minehunter of the MHC-51 “Osprey” class”

“The issues of electro-magnetic transparency, noise and vibration attenuation, underwater shock resistance and non-magnetic characteristics are effectively managed and engineered at Intermarine.”

“In support of the GRP vessel design, Intermarine developed sophisticated resin impregnators so that the very heavy woven roving glass fabrics can be efficiently handled.”

(p37) “Intermarine, USA P. O. Box 3045, Savannah, Ga. 31402-3045. (912)234-6579. Telefax (912) 234-0717”

Mrs. Beckwith and I visited the Cardinal at the Tampa Florida Navy station on the morning of Sunday, May 19, 1999, during Armed Forces weekend. We were the first group of about 30 people shown through the ship that morning. The following is a list of some of the things that we were told by the Navy personnel together with some of the things that were shown to us.

The ship contained no iron or other magnetic material.

The crew were warned not to have magnetic items in or on their clothing or personal effects. “Even a paper clip in your pocket could be lethal!”

The cabin doors were water tight, there were no windows other than along the front of the control house.

The following is from website www.navsource.org/archives:

The ship has a maximum operational depth of 1500 feet

The maximum speed is 10 knots

Displacement: 896 metric tons

Length: 188 feet

Draft: 13 feet

Speed: 10 knots

Propulsion: 2 Isotta Franschini non-magnetic diesel engines driving two Voith Schneider vertical axis, cycloidal, controllable pitch propellers

No longitudinal or transverse hull framing. The skin carries all the stresses. The vessel is flexible under shock. Machinery is supported by cradles from the main deck

Crew: 51-5 officers, 46 enlisted

The ship “was in the Persian Gulf on Friday, in Tampa yesterday, Saturday, and will operate in Japan on Monday.”

The ship is safe in harbors having potentially unfrieldlies present so long as they are operating in the invisible mode. They duty is very dicey, however, when they must become visible so as to go on deck and secure a mine brought up to take back for reverse engineering of the latest triggering means.

We saw three large “degaussing” cabinets the size of a double width refrigerator manufactured by Marconi of Italy. (There is nothing magnetic to degauss!)

One of the cabinets had a small indicator light labeled “teleportation mode”!

The minehunter was the choice duty in the Navy coming ahead of submarine duty. Minehunter training used a mission control display showing a harbor with an icon for the ship. The display used about a two mile square map identifying the ship location in plain english. The mission control officer told us that actual duty was the same as the training with the location “blinking” from one harbor somewhere on Earth to another. This capability was well known in at least parts of the Navy represented by the crew as a very poorly kept secret, thus becoming the choice of Navy assignments. The engineering officer on the Cardinal had been the engineering officer on a carrier but said that he chose this duty as “where the action is”. His engineering crew on the carrier was much larger than the crew of about 65 on the Cardinal.

The stories of Tesla's work, of the IX97 and of the Cardinal have been covered in some detail as evidence supporting my new theories of divided space on which this invention depends.

### DETAILED DESCRIPTION OF THE PREFERRED EMBODIMENTS

FIG. 9 shows a sending device for sending divided space globes at nearly infinite speeds. The sending device is made up of all of the components shown in FIG. 9 with a choice of device 7 or 20 as described hereinunder in detail. FIG. 9 d) shows a receiving device 7 for the TS frequency as described in my referenced U.S. patent application Ser. No. 09/286,068, APPARATUS FOR OBTAINING WORLDWIDE DATA ON THE EARTH'S RESONANT FREQUENCY. On FIG. 5 of that application three phase outputs at the TS frequency are shown driving a synchronous motor. The present invention extends this idea to the provision of commutated four phase outputs providing square wave output currents that rotate from A to B to C to D to A etc. In general multiple phases may be provided as required to fit an application. Currents of any wave shape may also be provided for the phases as required to fit an application.

TS receiver device 7 commutates up to 60 amperes of current synchronous with the TS frequency into the conductors of current loops A, B, C, and D respectively identified as 1, 2, 3, and 4. These current loop sources have no connections to other circuits. The current loops are preferably made using #8 copper wire. Center points in said conductor loops are connected to common point 5 shown in FIGS. 9a) and 9b). Invisible globes 6 of divided space are shown in FIG. 9b) where they would actually be in contact with conductor loops 1, 2, 3, and 4. Current loops 1, 2, 3, and 4, are shown in both FIGS. 9a) and c) with only loop 3 shown in FIG. 9b. Block 8 of FIG. 9b) is a 3 phase antenna driver shown in greater detail in FIG. 9e). Preferably said driver device 8 operates at 900 mHz where many required components and test equipment are readily available. Selectively operation is at higher frequencies yielding smaller globes and higher data rates. Receiver device 7 is preferably controlled by a program in an interconnected computer, not shown.

Driver device 8 supplies 3 phase signals at phase angles of 120° to antennae 9, 10 and 11 as shown in FIG. 9b). Antennae 9, 10 and 11 are physically separated by 90° symmetrically disposed around the horizontal axis of FIG. 9b). This gives a force to the left propelling information globes at nearly infinite speed along said horizontal axis. As described hereinabove this is the same phenomena as the use of three phase symmetrical currents to propel electric power along a three phase electric power transmission line.

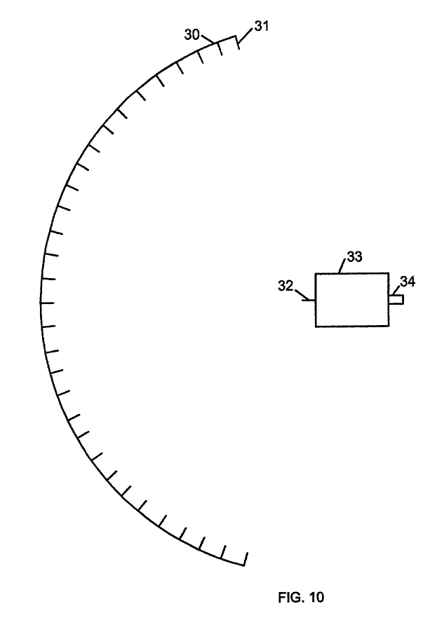

Data is sent using the sending of a globe representing a binary one and absence representing a binary zero. The data bit rate is at any rate up to the rate wherein one bit time is the time required to separate a globe into divided space. Assuming that this is found to be one turn (360°) at the selected antenna drive frequency, the maximum data rate is equal to the said drive frequency. A bit time, and therefore the bit rate, is selected for the requirements of the information to be sent by the sending device described in FIG. 9. The bit rate at receiving device 33, FIG. 10, is preset to be the same. Should the bit time be greater than the time to send one globe then the globe can be sent repeatedly increasing the number of globes sent and received in a bit time. Various methods of using the maximum available bit rate to improve the reliability of data at a lower bit rate are well known.

The upper boundary of the Earth's TS energy is believed to be at the ionosphere. Above this boundary where most satellites operate use of the TS frequency is not available for forming divided space balls. On the moon and planets not having an active equivalent to the electromagnetic field found on Earth energy for producing divided space is also not available. In these applications of this invention, an alternate method is shown in FIG. 9f) which is used in place of TS receiver 7. Alternate divided space driver 20 has a source of direct current 21 which is commutated to current loop outputs A, B, C and D rotating at a selected frequency. These current loops sources are isolated from any other circuits.

FIG. 10 shows devices for receiving said globes consist of a focusing circular parabolic reflector 30 having an array of antennae 31 which are one quarter wave length at the selected frequency used in said sending devices as described in FIG. 9. These antennae 31 are excited by receipt of globes which puncture the globes and are electrically excited by the 900 mHz signals contained in the globes. The principle of a divided space globe yields a good explanation for ball lightning which is known to roll along the ground and electric poser lines until punctured by a sharp object. The ball of energy is then released and acts destructively much as if the original lightning were recreated. Fortunately the amount of energy contemplated in this invention is very small so as to be safe.

Signals received from the globes by the antennae are reflected to antenna 32 of common 900 mHz receiving device 33. Antenna 32 is located at the focal point of reflector 30 so as to pick up signals from at least one of the antennae 31 for each globe send by the sending device. The received pulses representing binary data are suitably converted to a serial binary output using well known technology and transmitted to other locations over fiber axial cable 34. Alternatively other well known means of outward communications such as wireless, wire, and coax cable can be used. The receiving reflector 31 is sized to accommodate the angle within which the sending device must track in direction.

The power used for the information globes is quite small since the information does not disperse in the same manner as radio waves. Data security is inherent both due to the high data rates possible but also due to difficulty of interception and invisibility of any beam.

Advantages of the Invention

1. Real time communications, including video, to line of site locations, to spacecraft and to bases on the Moon and other planets such as Mars where bases may be possible.

2. Light weight capable of use in a satellite.

3. Security from detection by conventional equipment.

4. Security of detection by receivers of this invention without giving an alarm due to interruption of the beam.

1. A method for communicating at speeds approaching infinity, the method consisting of the steps of:
a) receiving in receivers the fundamental active component of the Earth's electromagnetic frequency,
b) outputting multiple phase currents from said receivers,
c) conducting said currents in conductors surrounding globes of space so as to form globes of divided space,
d) forming three phase positive-phase-sequence electromagnetic energy within said globes whereby force is created in the desired direction of sending information,
e) sending said globes in a binary time sequence representing information, and
f) receiving said globes
whereby information is conveyed in nearly zero time regardless of distances.

2. A method as in claim 1 further consisting of the step of turning said rotating magnetic fields “on” and “off” in response to the binary information data sequences being sent
whereby divided space globes of electromagnetic energy are transmitted in a binary time sequence at nearly infinite speeds.

3. A method as in claim 1 further consisting of the steps of:
a) forming parabolic reflectors for electromagnetic waves,
b) pointing said parabolic reflectors in the said desired direction of sending information so as to receive said information,
c) placing multiple antennae on the surface of said parabolic reflectors so as to puncture said globes when received and transform said electromagnetic energy contained in said globes into electromagnetic energy on at least one said multiple antennae,
d) placing single antennae for said electromagnetic waves at focal points of said parabolic reflectors,
e) determining times for receiving said transmitted ones and zeros,
f) turning said electromagnetic waves when received into signals representing binary ones, and
f) creating binary zeros when said electromagnetic waves are not received
whereby said sending binary time sequence representing information is received.

4. A method for communicating at speeds approaching infinity, the method consisting of the steps of:
a) selecting a frequency for the formation of globes of divided space,
b) forming multiple phase currents at said selected frequency,
c) conducting said currents in conductors surrounding globes of space so as to form globes of divided space,
d) forming three phase positive-phase-sequence electromagnetic energy within said globes whereby force is created in the desired direction of sending information,
e) sending said globes in a binary time sequence representing information, and
f) receiving said globes
whereby information is conveyed in nearly zero time regardless of distances.

5. A method as in claim 4 further consisting of the step of turning said rotating magnetic fields “on” and “off” in response to the binary information data sequences being sent
whereby divided space globes of electromagnetic energy are transmitted in a binary time sequence at nearly infinite speeds.

6. A method as in claim 4 further consisting of the steps of:
a) forming parabolic reflectors for electromagnetic waves,
b) pointing said parabolic reflectors in the said desired direction of sending information so as to receive said information,
c) placing multiple antennae on the surface of said parabolic reflectors so as to puncture said globes when received and transform said electromagnetic energy contained in said globes into electromagnetic energy on at least one said multiple antennae,
d) placing single antennae for said electromagnetic waves at focal points of said parabolic reflectors,
e) determining times for receiving said transmitted (ones) and (zeros),
f) turning said electromagnetic waves when received into signals representing binary ones, and
f) creating binary zeros when said electromagnetic waves are not received
whereby said sending binary time sequence representing information is received.

7. Apparatus for communicating at speeds approaching infinity comprising in combination:
a) receivers for the fundamental active component of the Earth's resonant frequency,
b) multiple phase outputs of the fundamental active component of the Earth's resonant frequency from said receivers,
c) circuits which deliver AC currents for each of said multiple phases, and
d) conductors for said AC currents around a globe of space for said currents which enter around one point and which connect together at a common point on the opposite side of said globe,
whereby globes are formed in divided spaces capable of traveling at nearly infinite speeds.

8. Apparatus as in claim 7 further comprising in combination:
a) devices for producing three phase positive-phase-sequence currents at a selected frequency, and
b) three antennae within said cavities fed by said three phase positive-phase-sequence currents which form electromagnetic field energy which has a force capable of driving globes of divided space containing said energy in a desired direction.

9. Apparatus as in claim 8 further comprising in combination:
a) devices that turn on said three phase positive-phase-sequence currents for the time required to send a globe of divided space containing said electromagnetic field energy,
b) devices that determine a data transmission bit rate with one bit time equal to said time required to send a globe of divided space, and
c) coding devices which send a globe during a bit time so as to represent a binary one and do not send a globe during a bit time so as to represent a binary zero
whereby information is sent in a binary time sequence representing information at nearly infinite speeds.

10. Apparatus as in claim 8 further comprising in combination:
a) receiving devices which have a parabolic shape that reflects electromagnetic waves to antennae positioned at focal points of said parabolas,
b) antennae located on the surface of said reflectors that puncture received divided space globes and convert electromagnetic energy contained therein into electromagnetic energy on at least one of said antennae on the surface so as to be reflected to the single antenna located at focal points,
c) devices which respond to said data transmission bit rate and which convert electromagnetic energy obtained from said antennae during expected bit times at focal points to signals representing binary ones and lack of said electromagnetic energy during expected bit times to binary zeros, and
d) circuitry which bring binary time sequences representing information out for external uses.
